(19) United States
(12) Patent Application Publication
(10) Pub. No.: US 2022/0222175 A1
(43) Pub. Date: Jul. 14, 2022

(54) INFORMATION PROCESSING SYSTEM, INFORMATION PROCESSING APPARATUS, AND METHOD FOR PROCESSING INFORMATION

(71) Applicant: FUJITSU LIMITED, Kawasaki-shi (JP)

(72) Inventor: Jun KATO, Kawasaki (JP)

(73) Assignee: FUJITSU LIMITED, Kawasaki-shi (JP)

(21) Appl. No.: 17/493,883

(22) Filed: Oct. 5, 2021

(30) Foreign Application Priority Data
Jan. 13, 2021 (JP) 2021-003717

(51) Int. Cl. G06F 12/06; G06F 12/0891

(52) U.S. Cl. CPC G06F 12/0646; G06F 2212/601; G06F 2212/604; G06F 12/0891

(57) ABSTRACT

A system including first and second apparatuses. To the second apparatus, the first apparatus transmits a writing request including a fingerprint (FP) of writing target data to be written into the second apparatus connected thereto via a network when the FP exists in a first storing region that stores FPs, and transmits a writing request containing the FP and the writing target data when the FP does net exist. When determining that writing requests of the received FPs have sequentiality based on writing positions on a data layout of a second storing region that stores FPs of data written into a storing device in a sequence of writing the data, the second apparatus reads a subsequent fingerprint to the fingerprints on the data layout, and transmits the subsequent fingerprint to the first apparatus, which then stores the received subsequent fingerprint into the first storing region.

### CROSS-REFERENCE TO RELATED APPLICATION

This application is based upon and claims the benefit of priority of the prior Japanese Patent application No. 2021-003717, filed on Jan. 13, 2021, the entire contents of which are incorporated herein by reference.

### FIELD

The embodiment discussed herein relates to an information processing system, an information processing apparatus, and a method for processing information.

### BACKGROUND

As an example of an information processing system including multiple information processing apparatuses, a block storage system is known in which a computing server and a storage server are communicably connected to each other via a network.

[Patent Document 1] Japanese Laid-open Patent Publication No. 2018-142314

[Patent Document 2] Japanese Laid-open Patent Publication No. 2018-185760

[Patent Document 3] Japanese Laid-open Patent Publication No. 2005-202942

In a block storage system, when data is written from a computing server into a storage server, passage of data through a network causes communication.

For example, by employing a contents cache in a computing server, passage of data through the network can be suppressed in terms of writing cache-hit data, which means that deduplication is enabled. On the other hand, cache-miss data is not deduplicated.

As described above, depending on the operation mode of the information processing system, the tendency of writing accesses to the information processing apparatus, and the like, the effect of deduplication in reducing data traffic may lower with, for example, an increase in frequency of cache misses.

### SUMMARY

According to an aspect of the embodiments, an information processing system includes: a first information processing apparatus; and a second information processing apparatus connected to the first information processing apparatus via a network. The first information processing apparatus includes a first memory, a first storing region that stores a fingerprint of data, and a first processor coupled to the first memory and the first storing region. The first processor is configured to transmit, in a case where a fingerprint of writing target data to be written into the second information processing apparatus exits in the first storing region, a writing request including the fingerprint to the second information processing apparatus, and transmit, in a case where the fingerprint does not exist in the first storing region, a writing request containing the writing target data and the fingerprint to the second information processing apparatus. The second information processing apparatus includes a second memory, a second storing region that stores respective fingerprints of a plurality of data pieces written into a storing device in a sequence of writing the plurality of data pieces, and a second processor coupled to the second memory and the second storing region. The second processor is configured to receive a plurality of the writing requests from the first information processing apparatus via the network, determine, based on writing positions of the plurality of the fingerprints included in the plurality of writing requests on a data layout of the second storing region, whether or not the plurality of writing requests have sequentiality, read, when determining that the plurality of writing requests have sequentiality, a subsequent fingerprint to the plurality of fingerprints on the data layout of the second storing region, and transmit the subsequent fingerprint to the first information processing apparatus. The first information apparatus stores the subsequent fingerprint into the first storing region.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a first configuration example of a block storage system;

FIG. 2 is a diagram illustrating a second configuration example of a block storage system;

FIG. 3 is a diagram illustrating a third configuration example of a block storage system;

FIG. 4 is a diagram illustrating a fourth configuration example of a block storage system;

FIG. 5 is a diagram illustrating an example of a configuration in which a local cache is provided to a computing server in the first configuration example of FIG. 1 or the third configuration example of FIG. 3;

FIG. 6 is a diagram illustrating a detailed example of the fourth configuration example of FIG. 4;

FIG. 7 is a diagram illustrating an example of a scheme to reduce data traffic by using cache in the block storage system of FIG. 6;

FIG. 8 is a diagram illustrating an example in which a contents cache is effective;

FIG. 9 is a diagram briefly illustrating a scheme according to one embodiment;

FIG. 10 is a diagram illustrating an example of sequential determination according to the one embodiment;

FIG. 11 is a diagram illustrating an example of a relationship between a data layout on a storage and sequential determination;

FIG. 12 is a diagram illustrating an example of a relationship among a data layout on a storage, sequential determination, and prefetching;

FIG. 13 is a diagram illustrating an example of a compaction process of fingerprints according to the one embodiment;

FIG. 14 is a block diagram illustrating an example of a functional configuration of a block storage system according to the one embodiment;

FIG. 15 is a diagram illustrating an example of a hit history table;

FIG. 16 is a diagram illustrating an example of an FP history table;

FIG. 17 is a diagram illustrating an example of operation of a parameter adjusting unit;

FIG. 18 is a diagram illustrating an example of a compaction process triggered by a prefetching hit;

FIG. 19 is a diagram illustrating an example of a compaction process;

FIG. 20 is a diagram illustrating an example of a compaction process triggered by sequential determination;

FIG. 21 is a flow diagram illustrating an example of operation of a computing server according to the one embodiment;

FIG. 22 is a flow diagram illustrating an example of operation of a storage server according to the one embodiment;

FIG. 23 is a flow diagram illustrating an example of a prefetching process by the storage server of FIG. 22;

FIG. 24 is a diagram illustrating an application example of a scheme according to the one embodiment;

FIG. 25 is a diagram illustrating an application example of a scheme according to the one embodiment;

FIG. 26 is a diagram illustrating an application example of a scheme according to the one embodiment; and

FIG. 27 is a block diagram illustrating an example of a hardware (HW) configuration of a computer.

### DESCRIPTION OF EMBODIMENT

Hereinafter, an embodiment of the present invention will now be described with reference to the accompanying drawings. However, the embodiment described below is merely illustrative and there is no intention to exclude the application of various modifications and techniques that are not explicitly described below. For example, the present embodiment can be variously modified and implemented without departing from the scope thereof. In the drawings to be used in the following description, like reference numbers denote the same or similar parts, unless otherwise specified.

### <1> One Embodiment

### <1-1> Description of Block Storage System

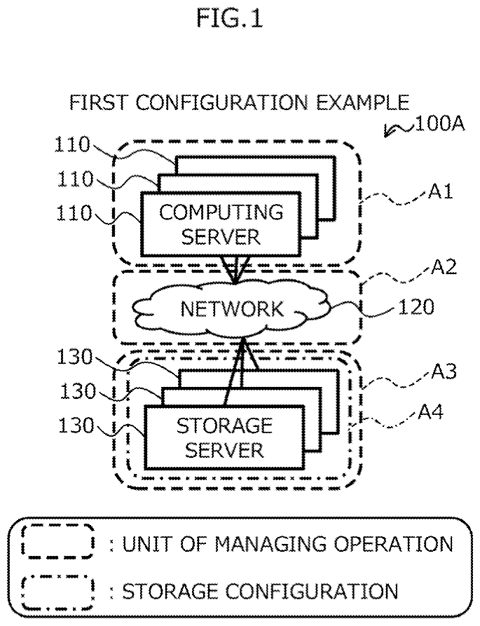

FIGS. 1 to 4 are diagrams illustrating first to fourth configuration examples of a block storage system, respectively.

As illustrated in FIG. 1, a block storage system 100A according to a first configuration example may have a configuration in which multiple computing servers 110 are communicably connected to multiple storage servers 130 via a network 120. In the block storage system 100A, as indicated by reference numbers A1 to A3, respective units of managing operation of the multiple computing servers 110, the network 120, and the multiple storage servers 130 are independent from one another. Since the block storage system 100A includes the multiple computing servers 110, the network 120, and the multiple storage servers 130 independently from one another, the storage indicated by reference number A4 and the computing can be independently scaled up (e.g., a server(s) can be added).

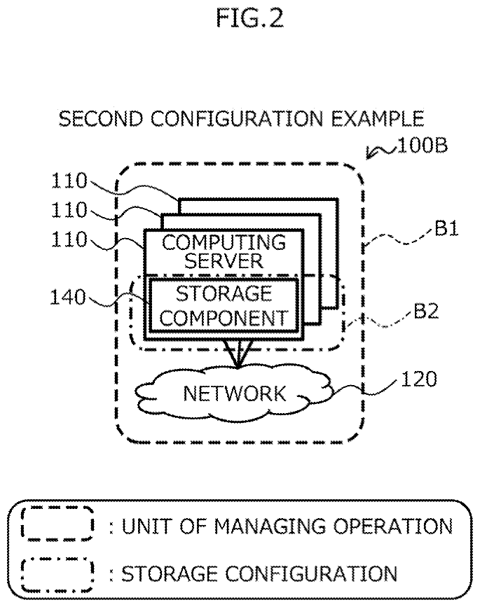

As illustrated in FIG. 2, a block storage system 100B according to a second configuration example may have a configuration in which multiple computing servers 110 are communicably connected to each other via a network 120. As indicated by reference number B1, in the block storage system 100B, the infrastructure can adept centralized management by collectively treating the multiple computing servers 110 and the network 120 as a single unit of managing operation. Further, by providing a storage component 140 having a storage function to the computing server 110, an access speed can be accelerated by using, for example, a cache of the storage component 140.

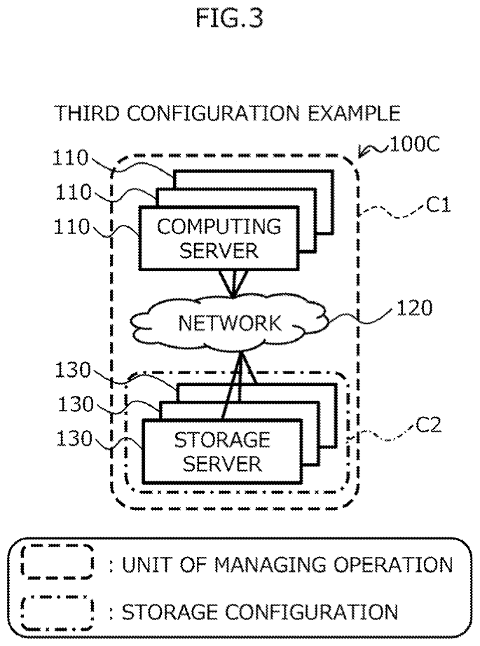

As illustrated in FIG. 3, a block storage system 100C according to a third configuration example may have a configuration in which multiple computing servers 110 are communicably connected to multiple storage servers 130 via a network 120. As indicated by reference number C1, in the block storage system 200C, the infrastructure can adopt centralized management by collectively treating the multiple computing servers 110, the network 120, and the multiple storage servers 130 as a single unit of managing operation. Furthermore, since the block storage system 100C includes the multiple computing servers 110, the network 120, and the multiple storage servers 230 independently from one another, the storage indicated by reference number C2 and the computing can be independently scaled up (e.g., a server(s) can be added).

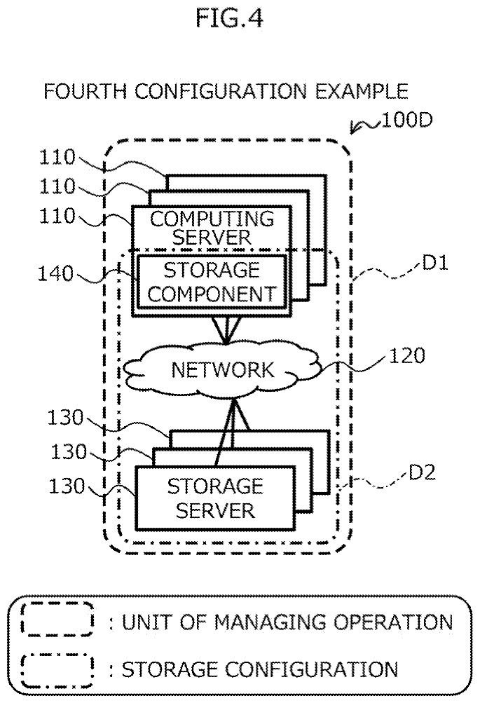

As illustrated in FIG. 4, a block storage system 100D according to a fourth configuration example may have a configuration in which multiple computing servers 110 are communicably connected to multiple storage servers 130 via a network 120. As indicated by reference number D1, in the block storage system 100D, the infrastructure can adopt centralized management by collectively treating the multiple computing servers 110, the network 120, and the multiple storage server 130 as a single unit of managing operation like FIGS. 2 and 3. Furthermore, since the block storage system 100D includes the multiple computing servers 110, the network 120, and the multiple storage servers 130 independently from one another, the storage indicated by reference number D2 and the computing can be independently scaled up (e.g., a server(s) can be added) like FIGS. 1 and 3. Further, by providing a storage component 140 having a storage function to the computing server 110, an access speed can be accelerated by using, for example, a cache of the storage component 140 like FIG. 2.

In the first, third, and fourth configuration examples illustrated in FIGS. 1, 3, and 4, since the destination of data to be written by the computing server 110 is a drive of the storage server 130, communication from the computing server 110 to the storage server 130 is generated. In the second configuration example illustrated in FIG. 2, the computing server 110 may be multiplexed (e.g., duplicated). In this case, communication occurs when the computing server 110 writes the data written in the storage component 140 into another computing server 110 in order to maintain a duplicated state.

For example, by employing a contents cache in the computing server 110, passage of data through the network 120 can be suppressed in terms of writing cache-hit data, which means that deduplication, is enabled.

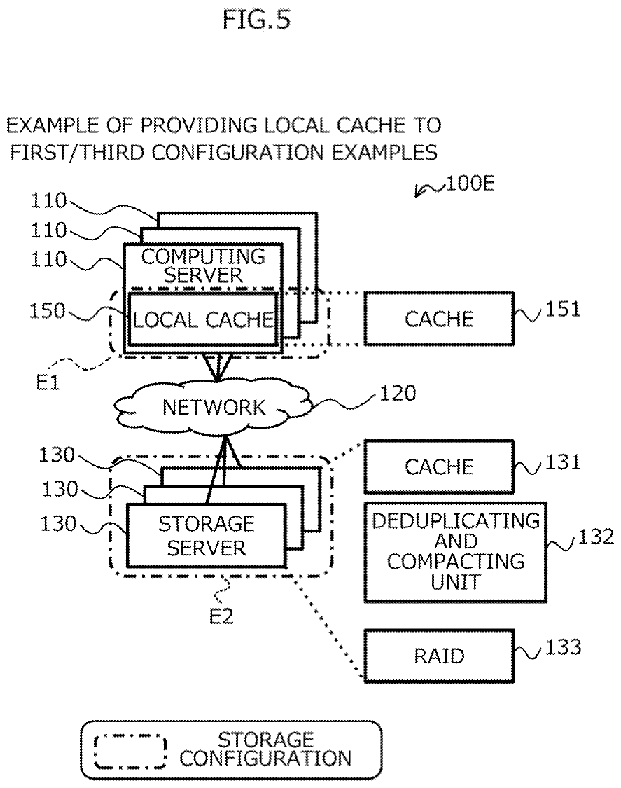

FIG. 5 is a diagram illustrating an example of a configuration of a block storage system 100B in which a local cache 150 is provided to each computing server 110 in the first configuration example illustrated in FIG. 1 or the third configuration example illustrated in FIG. 3.

Each local cache 150 includes a cache 151. The storage server 230 includes a cache 131, a deduplicating and compacting unit 132 that deduplicates and compresses data, and a Redundant Arrays of Inexpensive Disks (RAID) 133 that stores data. In the first and third configuration examples, as illustrated in FIG. 5, since the computing represented by reference number E1 and the storage represented by reference number E2 are independent from each other, the overall block storage system 100E includes two caches, which wastes processes and resources.

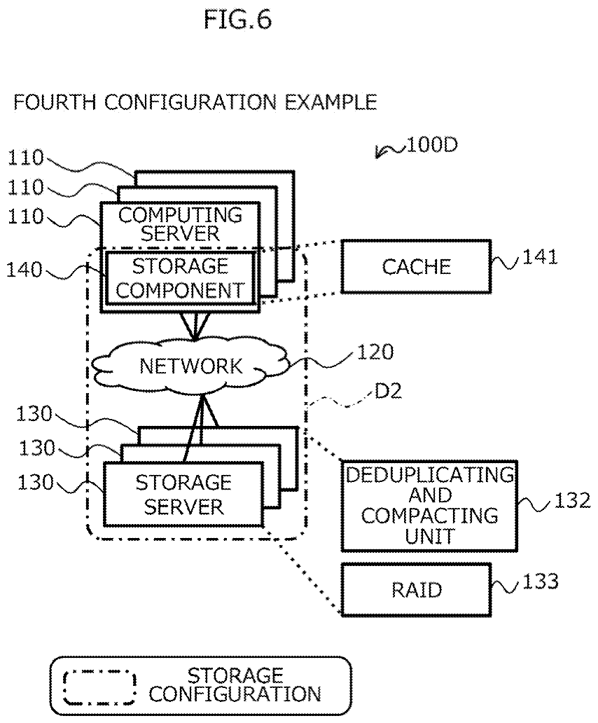

FIG. 6 is a diagram illustrating a detailed example of the fourth configuration example illustrated in FIG. 4. As illustrated in FIG. 6, in the block storage system 100D, the storage component 140 includes a cache (e.g., a contents cache) 141. The storage server 130 includes a deduplicating and compacting unit 132 and a RAID 133. In the block storage system 100D according to the fourth configuration example, as indicated by reference number D2 in FIG. 6, the computing servers 110 (storage component 140) and the storage servers 130 are tightly coupled to each other. Therefore, it is possible to reduce or eliminate waste of processing and resources in the entire block storage system 100D. In the second configuration example illustrated in FIG. 2, also in cases where a function for deduplicating and compressing is provided to the side of the computing servers 110 into which data for maintaining the duplicated state is written, it is possible to reduce or eliminate waste of processing and resources since the computing servers 110 are tightly coupled.

However, in either of the examples of FIG. 5 and FIG. 6, cache-miss data is not deduplicated. This means that, depending on the respective operating modes of the block storage systems 100A to 100D, the tendency of writing accesses to the storage servers 130 or the computing servers 110, and the like, the effect of deduplication in reducing data traffic may lower with, for example, an increase in frequency of cache misses.

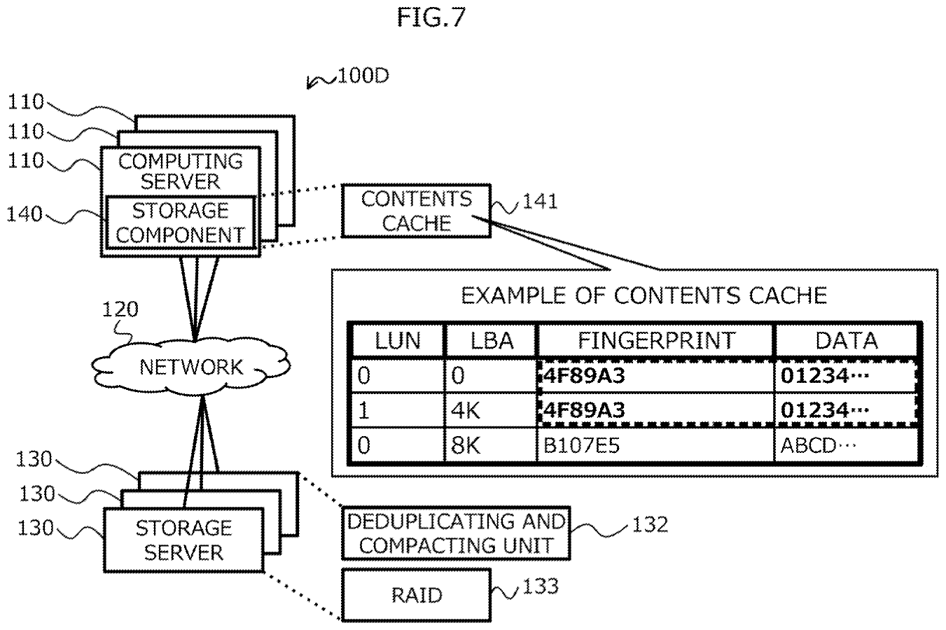

FIG. 7 is a diagram illustrating an example of a scheme to reduce data traffic by using the cache (contents cache) 141 in the block storage system 100D of FIG. 6.

The contents cache 141 is, for example, a deduplicated cache and may include, by way of example, a “Logical Unit Number (LUN),” a “Logical Block Address (LBA),” a “fingerprint,” and “data.” A fingerprint (FP) is a fixed-length or variable-length data string calculated on the basis of data, and may be, as an example, a hash value calculated by a hash function. Various hash functions such as SHA-1 can be used as the hash function.

As illustrated in FIG. 7, the storage component 140 calculates an FP (e.g., a hash value such as a SHA-1) of writing target data from the writing target data, and determines whether or not the same data that has the same FP exists in the contents cache 141. If the same data exists, the storage component 140 transmits the FP, the LUN, and the LBA to the storage server 130 to deter transmission of data that has already been transmitted in the past.

In the example of FIG. 7, among the three entries of the contents cache 141, data of only two entries are cached due to deduplication. In addition, in the event of communication, the data “01234 . . . ” is not transmitted twice. For example, the data “01234 . . . ” is transmitted only at the first time among the entries of the contents cache 141, and only metadata, such as an FP, an LUN, and an LBA, is transmitted at the second and subsequent times.

Accordingly, the efficiency of the cache capacity can be enhanced, and from the viewpoint of communication, the data transfer amount at the time of writing can be reduced.

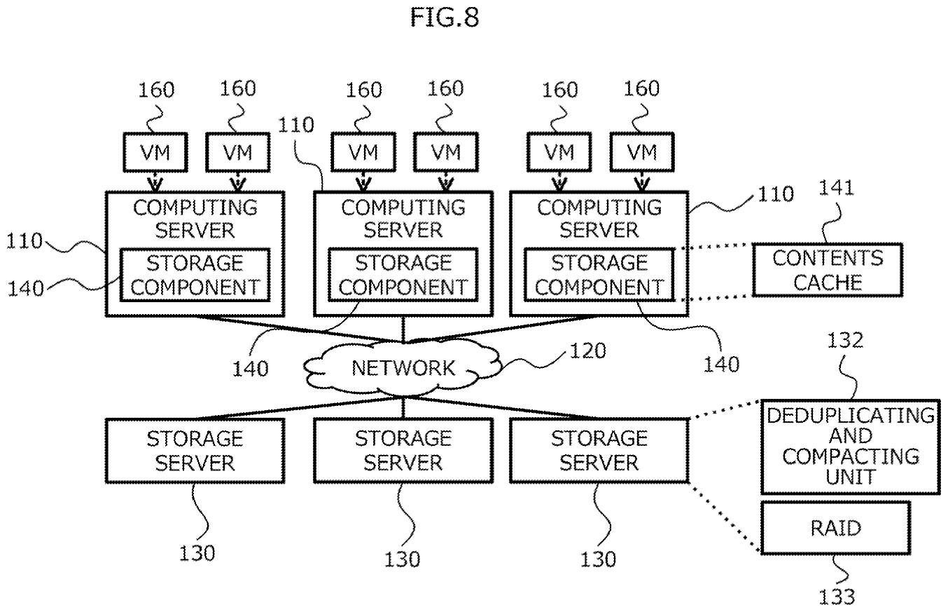

An effective example brought by the contents cache 141 is, as illustrated in FIG. 8, a case where, using the computing server 110 as a virtualization infrastructure, a definition file of antivirus software is updated on a virtual desktop running on the virtualization infrastructure. In the example of FIG. 8, such a virtual desktop is referred to as a Virtual Machine (VM) 160.

When the definition files are updated upon the starts of the virtual desktops, multiple writings of the same data occur from multiple virtual desktops to the storage servers 130 around the working start time. These writings allow the data to be fetched (stored) in the contents cache 141 because the size of the data related to the writings is small and the writings occur at substantially the same time.

In the example of FIG. 8, writing occurs from two VMs 160 per one computing server 110, but since the data body is transferred only once in the overall writing, the number of times of transferring the data body for three computing servers 110 can be reduced from six to three.

As described above, unless deduplication is performed in the contents cache 141, the data traffic is not reduced. In other words, unless the data exists in the contents cache 141 (the cache hit occurs), the data traffic is not reduced. Another conceivable approach is to compress data, which reduces data traffic by as low as about 30 to 40 percent, but does not result in a drastic change in suppressing transmission of the entire data as achieved by deduplication.

One of the causes that the contents cache 141 is not deduplicated is unsuccessful deduplication of the contents cache 141 in a situation where the content was previously written. In this case, although data traffic increases, the deduplication might be possible if inquiry is made to the storage server 130. The underlying cause is that the contents cache 141 of the computing server 110 stores only part of the FPs throughout the system.

An example of a use case of a block storage system is a case where multiple users store a data set into the storage servers 130 for machine learning of Artificial Intelligence (AI).

The data set used in the machine learning of AI can be tens of PBs (petabytes). For example, the users download the data set from a community site and deploy it onto the storage servers 130. It is assumed that the data sets used in machine learning have the same data and a similar writing sequence.

In terms of the storage capacity of the contents cache 141, it is difficult to place all writings of a data set of several tens of PBs in the contents cache 141. However, the data sets, which contain the same data and similar writing sequence, have regularity.

With the foregoing in view, description of the one embodiment will be made in relation to, as an example of a scheme to reduce data traffic when data is written into an information processing apparatus, a scheme that achieves deduplication in writing data sets from the second and subsequent users by using regularity.

The following description is based on the block storage system 100D according to the fourth configuration example. However, the scheme according to the one embodiment is also applicable to writing for duplication in the block storage system 100B according to the second configuration example. In other words, in terms of an I/O (Input/Output) path, the computing server 110 serving as a writing destination of the block storage system 100B can be treated the same as the storage server 130 in the block storage system 100D.

The computing server 110 is an example of a first information processing apparatus, and the storage server 130 is an example of a second information processing apparatus. Further, in cases where the multiple computing servers 110 have a redundant configuration and data is written between the computing servers 110 in the example illustrated in FIG. 2, the computing server 110 serving as a writing source of the data is an example of the first information processing apparatus and the computing server 110 serving as a writing destination of the data is an example of the second information processing apparatus.

### <1-2> Description of One Embodiment:

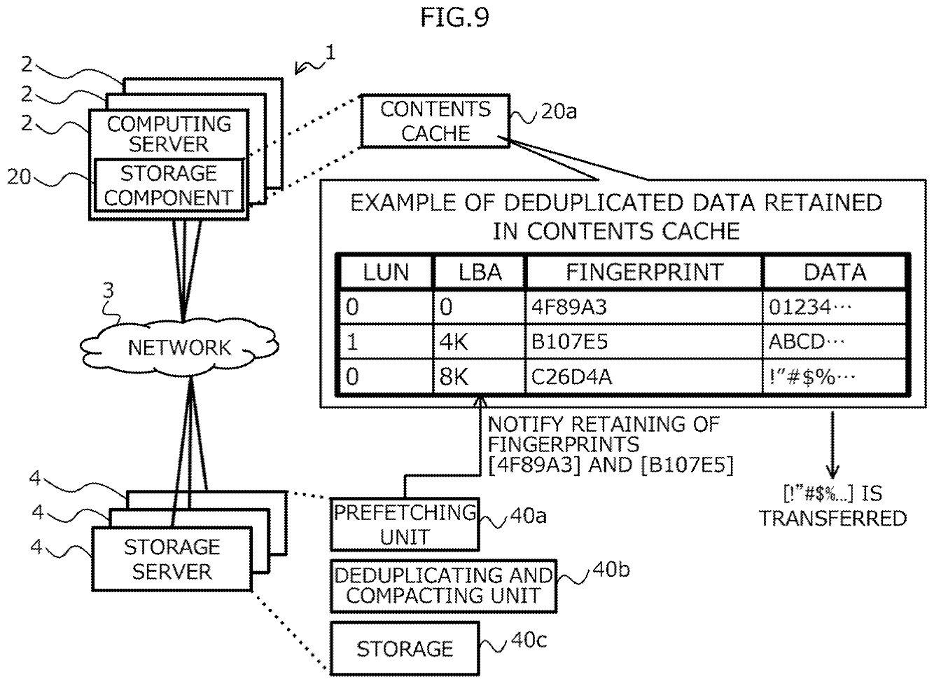

FIG. 9 is a diagram briefly illustrating a scheme according to the one embodiment. As illustrated in FIG. 9, a block storage system 1 according to the one embodiment, may illustratively include multiple computing servers 2, a network 3, and multiple storage servers 4. Each computing server 2 is an example of the first information processing apparatus or a first computer, and each storage server 4 is an example of the second information processing apparatus or a second computer connected to the computing servers 2 via the network 3.

Each computing server 2 may include a storage component 20 having a contents cache 20a. Each storage server 4 may include a prefetching unit 40a, a deduplicating and compacting unit 40b, and a storage 40c.

Each storage server 4 according to the one embodiment reduces data traffic by predicting regularity and transmitting an FP that is likely to be written by the computing server 2 to the contents cache 20a of the computing server 2 in advance.

For example, the storage server 4 prefetches an FP, focusing on sequentiality of data that can be detected inside the storage server 4. As illustrated in FIG. 9, the prefetching unit 40a notifies the storage component 20 that the prefetching unit 40a has already retained the FP [4P89A3] and the FP [B107E5]. On the basis of the notified FPs and the contents cache 20a, the storage component 20 transfers only the data [!″#$% . . . ] among the three data pieces, and therefore can reduce the data traffic of the two data pieces corresponding to the notified FPs.

As a scheme for detecting the regularity described above, time series analysis has been known, for example. Time series analysis is, for example, a scheme of analysis that provides an FP written for each LUN with a time stamp. In time series analysis, additional resources of the storage server 4 or a server on a cloud are used for managing the time stamp provided to each FP. In addition, when time series analysis is performed inside the storage of the storage server 4, the time series analysis, which is high in processing load, may be a cause of degrading the performance of the storage server 4.

For the above, the one embodiment focuses on sequentiality of data as the regularity. By using the sequentiality of data that can be detected inside the storage of the storage server 4 as the regularity, it is possible to complete the process within the storage. In order to enhance the detection accuracy, time series analysis may be employed as regularity in addition to the sequentiality of the data to the extent that the use of additional resources is permitted.

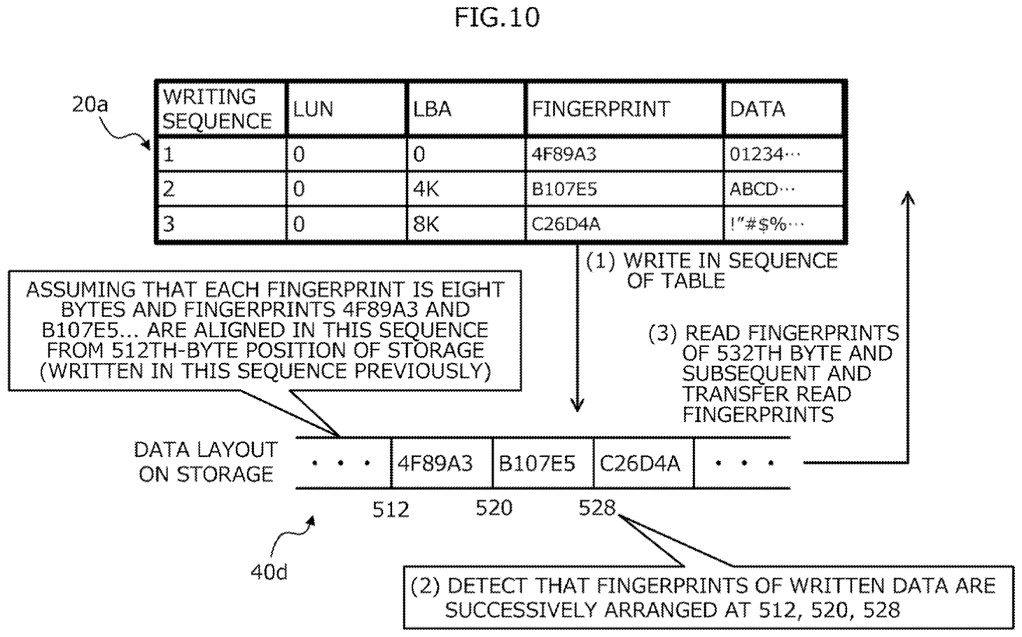

FIG. 10 is a diagram illustrating an example of sequential determination according to the one embodiment. As illustrated in FIG. 10, the sequential determination is performed on the basis of the position at which an FP is physically written into the storage 40c.

As illustrated in FIG. 10, it is assumed that, in the data layout of a storing region 40d on the storage 40c, eight-byte FPs are aligned in the sequence of [4F89A3], [B107E5], . . . from the position of 512th byte of the storage 40c (written in this sequence previously). Here, an FP is essentially written into the storage 40c at the initial writing in which deduplication is not performed. The storing region 40d illustrated in FIG. 10 is assumed to indicate a storage region that stores metadata among the storage 40c such as a RAID.

As illustrated in FIG. 10, the computing server 2 writes the FPs in the contents cache 20a into the storage server 4 collectively in the writing sequence in units of an LUN as much as possible (see reference number (1)). The storage server 4 detects, in the sequential determination, that the written FPs are sequentially arranged at 512th, 520th, and 528th bytes on the data layout of the storing region 40d, which means sequential writing (see reference number (2)).

In cases where the storage server 4 determines that the FPs are sequential (succeeds in determination), the storage server 4 reads the FPs at and subsequent to 532th byte on the data layout of the storing region 40d, which follow the received FPs, and transfers the read FPs to the computing server 2 (see reference numbers (3)).

Thereby, in cases where the FPs of the fourth and subsequent data in the writing sequence match the FPs received from the storage server 4, the computing server 2 can omit the transmission of the data as in the case of the first to third data. In other words, in the block storage system 1, it is possible to reduce the data traffic by deduplication.

The sequential determination described above is assumed to use the writing positions in the storage 40c, for instance, a disk group such as a RAID.

For example, in cases where the sequential determination uses LUNs and LBAs, since the data layout on the LUNs is based on the logical writing positions of the actual data, subsequent data is guaranteed to follow if being read sequentially on the basis of the LUNs and the LBAs. In other words, on the data layout on the LUN, the subsequent data is guaranteed to be the next data on the same LUN.

On the other hand, in the scheme of the one embodiment, the sequential determination depends on the writing sequence of the fingerprints. That is, in the example of FIG. 10, if the fingerprints can be written collectively “in the writing sequence in units of an LUN as much as possible” into the storage server 4, the possibility of the detection of sequentiality can be enhanced.

One of the cases where it is difficult, to write “in the writing sequence in units of an LUN as much as possible” is when writing of the metadata or a journal log of a file system occurs. For example, a block storage sometimes uses a file system. The file system sometimes writes, for example, metadata and a journal log into the storage 40c in addition to the data body in accordance with workload data of a user.

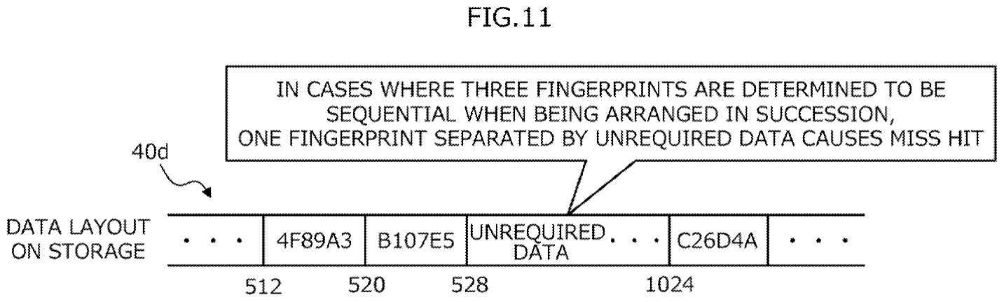

As illustrated in FIG. 11, containing time stamps, metadata and a journal log are not redundant to each other, and therefore easily come to be the factors in not determining the sequentiality (i.e., failing) in the sequential determination. Hereinafter, for convenience, data such as metadata and a journal log, and the FP thereof will be referred to as “unrequired data”. In order to abate the influence of noise due to such unrequired data in the sequential determination, it is conceivable to ease the criterion for determining the sequentiality, but easing the criterion may lead to excessive prefetching.

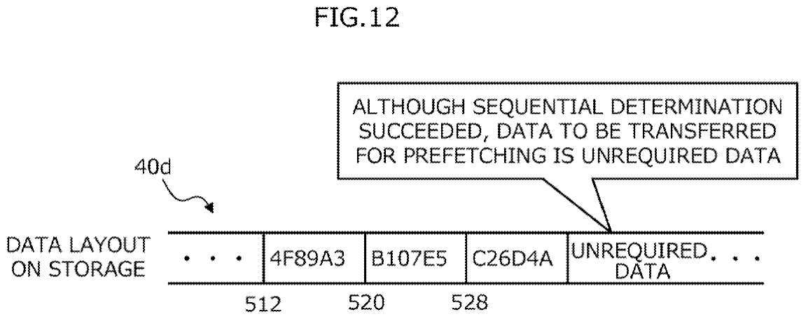

As illustrated in FIG. 12, as a result of excessive prefetching, unrequired data is sent to the contents cache 20a to lower the hit rate. Without cache hits, prefetching causes a waste of processing. Accordingly, it is desired to suppress the occurrence of excessive prefetching.

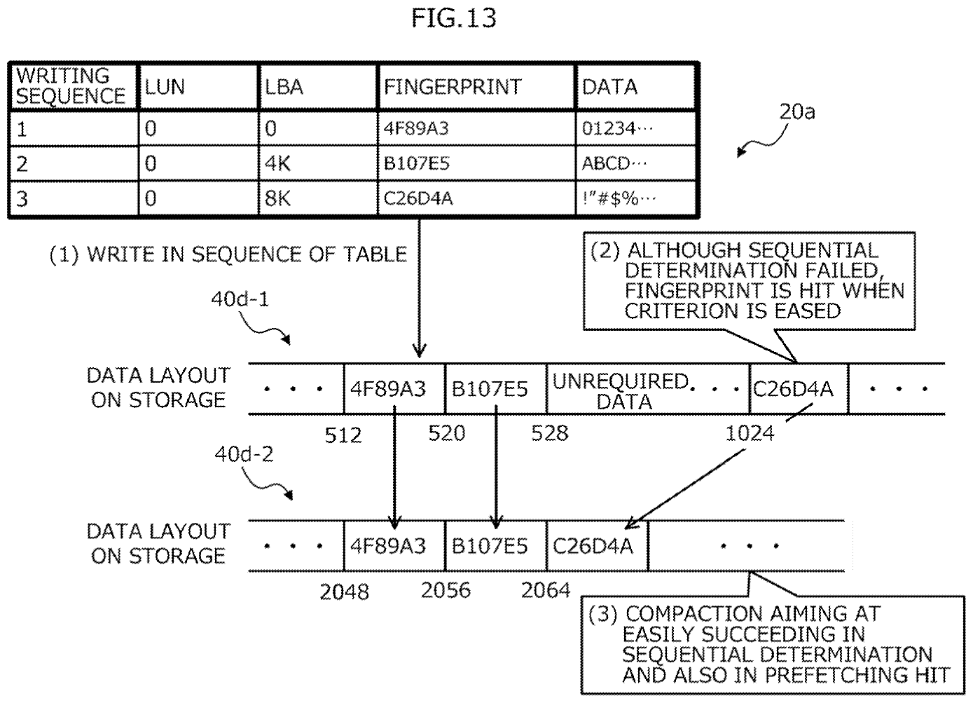

As a solution to the above, the block storage system 1 according to the one embodiment may perform compaction of FPs as illustrated in FIG. 13.

For example, as illustrated in FIG. 13, it is assumed that writing is performed in the sequence of the contents cache 20a by the computing server 2 (see reference number (1)). In the data layout of a storing region 40d-1, even when the sequential determination failed, the storage server 4 detects that the sequential determination is to succeed if the criterion for the sequential determination is eased (see reference number (2)). In this case, the storage server 4 may perform compaction of the FPs by sequentially arranging the FPs in another storing region 40d-2 after removing unrequired data in the storing region 40d-1 (see reference number (3)). The storage regions 40d-1 and 40d-2 are parts that store metadata such as FPs in the storage 40c. Even when the sequential determination succeeds, the storage server 4 may perform compaction if many pieces of unrequired data exist.

Thus, at the time of the next writing into the storage server 4, since compaction is already performed in the storing region 40d-2, the FPs therein are easily determined to be sequential and the storing region 40d-2 has a small number of pieces of unrequired data, which can enhance the prefetching hit rate.

As described above, according to the scheme of the one embodiment, by transferring FPs that are likely to cause cache hits in prefetching from the storage server 4 to the computing server 2 in advance, the deduplication rate can be enhanced by prefetching hits. This can reduce the data traffic.

For example, in the event of executing a workload of writing which has sequentiality and in which deduplication is effective, deduplication can be accomplished regardless of the size of the contents cache 20a even in large scale writing.

In addition, since compaction can remove unrequired data that causes errors in sequential determination and a decrease in the prefetching hit rate, the deduplication rate can be further enhanced at, for example, the third and subsequent writings.

### <1-3>Example of Functional Configuration:

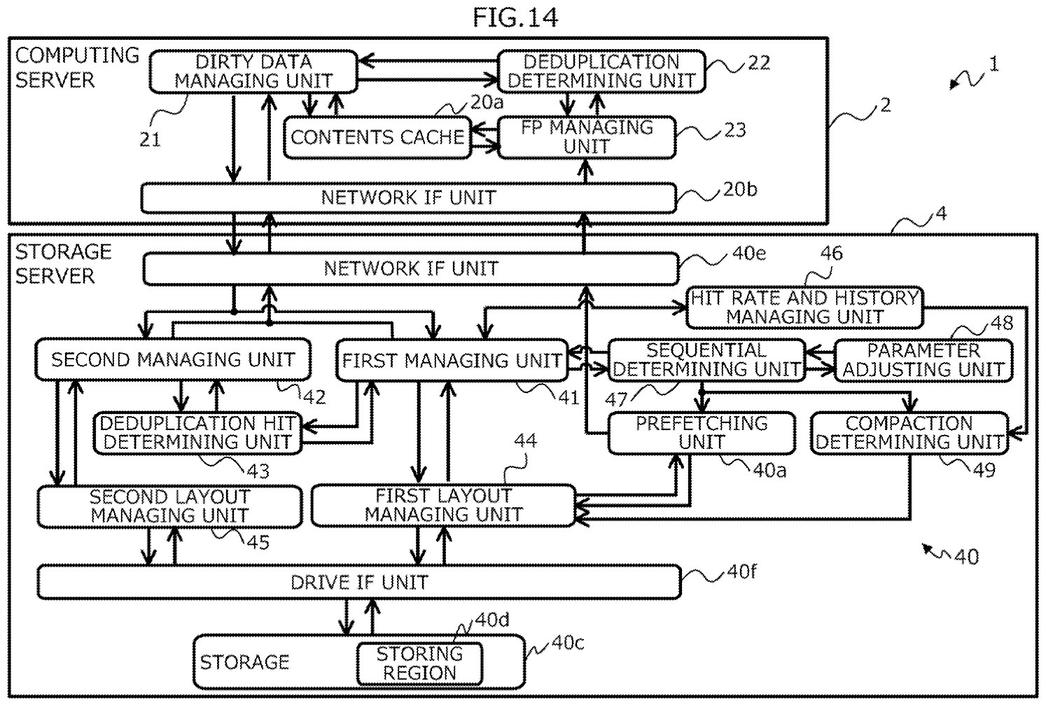

FIG. 14 is a block diagram illustrating an example of a functional configuration of the block storage system 1 of the one embodiment.

### (Computing Server 2)

As illustrated in FIG. 14, the computing server 2 may illustratively include the contents cache 20a, a dirty data managing unit 21, a deduplication determining unit 22, an FP (fingerprint) managing unit 23, and a network IF (Interface) unit 20b. The blocks 21-23, 20a, and 20b are examples of the function of the storage component 20 illustrated in FIG. 9. The function of the computing server 2 including blocks 21-23, 20a and 20b may be implemented, for example, by executing a program expanded in a memory by a processor of the computing server 2.

The contents cache 20a is, for example, a cache in which deduplication has been performed, and may include an “LUN”, an “LBA”, a “fingerprint”, and “data”, as the data structure illustrated in FIG. 7, as an example. The contents cache 20a is an example of a first storing region.

The dirty data managing unit 21 manages dirty data in the contents cache 20a, which has not yet been written into the storage server 4. For example, the dirty data managing unit 21 may manage metadata such as LUN+LBA along with dirty data. The dirty data managing unit 21 outputs data to the deduplication determining unit 22 when the deduplication determining unit 22 determines to perform deduplication.

The deduplication determining unit 22 calculates the FP of the data, and determines whether or not the deduplication of the data is to be performed. The FP calculated by the deduplication determining unit 22 is managed by the FP managing unit 23.

The FP managing unit 23 manages the FP held in the contents cache 20a. The FP managing unit 23 may manage FPs received from the prefetching unit 40a of the storage server 4 in addition to the FPs calculated from the data in the contents cache 20a.

The network IF unit 20b has a function as a communication IF to an external information processing apparatus such as the storage server 4.

### (Storage Server 4)

As illustrated in FIG. 14, the storage server 4 may illustratively include a network IF unit 40e, a first managing unit 41, a second managing unit 42, a deduplication hit determining unit 43, a first layout managing unit 44, a second layout managing unit 45, and a drive IF unit 40f. The storage server 4 may illustratively include, for example, a storage 40c, a hit rate and history managing unit 46, a sequential determining unit 47, a prefetching unit 40a, a parameter adjusting unit 48, and a compaction determining unit 49. The blocks 41-43 are examples of the deduplicating and compacting unit 40b illustrated in FIG. 9. The blocks 41-49, 40a, 40e, and 40f are examples of a control unit 40. The function of the control unit 40 may be implemented, for example, by executing a program expanded in a memory by a processor of the storage server 4.

The network IF unit 40e has a function as a communication IF to an external information processing apparatus such as the computing server 2.

The first managing unit 41 manages FPs that the storage server 4 holds. For example, the first managing unit 41 may read and write an FP from and to the back end through the first layout managing unit 44. The first managing unit 41 may, for example, receive a writing request including an FP of writing target data to be written into the storage 40c from the computing server 2 through the network 3 by the network IF unit 40e.

The second managing unit 42 manages data except for the FPs. For example, the second managing unit 42 may manage various data held by the storage server 4, including metadata such as a reference count and mapping from the LUN+LBA to the address of the data, a data body, and the like. The second managing unit 42 outputs the data body to the deduplication hit determining unit 43 in deduplication determination. The second managing unit 42 may read and write various data except for the FPs from the back end through the second layout managing unit 45.

The deduplication hit determining unit 43 calculates the FP of the data, and determines whether or not the deduplication of the data is to be performed. The PP calculated by the deduplication hit determining unit 43 is managed by the first managing unit 41.

The first layout managing unit 44 manages, through the drive IF unit 40f, the layout on the volume of the storage 40c when an PP is read or written. For example, the first layout managing unit 44 may determine the position of an FP to be read or written.

The second layout managing unit 45 manages, through the drive IP unit 40f, the layout on the volume of the storage 40c when reading or writing metadata such as a reference count and mapping from the LUN+LBA to the address of the data, the data body, and the like. For example, the second layout managing unit 45 may determine the positions of the metadata, the data body, and the like to be read and written.

The drive IF unit 40f has a function as an IF for reading from and writing to the drive of the storage 40c serving as the back end of the deduplication.

The storage 40c is an example of a storing device configured by combining multiple drives. The storage 40c may be a virtual volume such as RAID, for example. Examples of the drive include at least one of drives such as a Solid State Drive (SSD), a Hard Disk Drive (HDD), and a remote drive. The storage 40c may include a storing region (not illustrated) that stores data to be written and one or more storing regions 40d that store metadata such as an FP.

The storing region 40d is an example of a second storing region, and may store, for example, respective FPs of multiple data pieces written into the storage 40c in the sequence of writing the multiple data pieces.

The hit rate and history managing unit 46 determines the prefetching hit rate and manages the hit history.

For example, in order to determine the prefetching hit rate, when adding a prefetched FP to the contents cache 20a, the hit rate and history managing unit 46 may add, through the first managing unit 41, information indicating the prefetched FP, for example, a flag, to the FP. In cases where the FP with a flag is written from the computing server 2, which means prefetching hit, the hit ratio and history managing unit 46 may transfer the FP with the flag to the storage 40c through the first managing unit 41, to update the hit ratio. Incidentally, the presence or absence of a flag may be regarded as the presence or absence of an entry in a hit history table 46a to be described below. That is, addition of a flag to an FP may represent addition of an entry to the hit history table 46a.

Further, for example, the hit rate and history managing unit 46 may use the hit history table 46a that manages the hit number in the storage server 4 in order to manage the hit history of prefetching. The hit history table 46a is an example of information that records the number of time of receiving a writing request including an FP that matches an FP transmitted in prefetching for each of multiple FPs transmitted in prefetching.

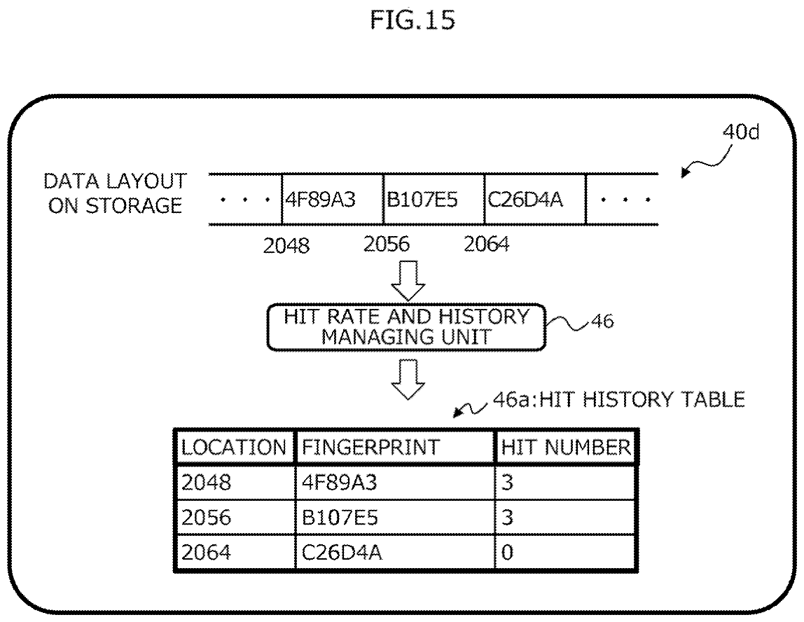

FIG. 15 is a diagram illustrating an example of the hit history table 46a. In the following description, the hit history table 46a is assumed to be data in a table form, for convenience, but is not limited thereto. Alternatively the hit history table 46a may be in various data forms such as a Database (DB) or an array. As illustrated in FIG. 15, the hit history table 46a may include items of “location”, “FP”, and “hit number” of the FPs on the data layout of the storing region 40d, for example. The “location” may be a location such as an address in the storage 40c.

The hit rate and history managing unit 46 may create an entry in the hit history table 46a when prefetching is carried out in the storage server 4. The hit rate and history managing unit 46 may update the hit number of the target FP upon a prefetching hit. The hit rate and history managing unit 46 may delete an entry when a predetermined time has elapsed after prefetching.

The sequential determining unit 47 performs sequential determination based on FPs. For example, the sequential determining unit 47 may detect the sequentiality of multiple received writing requests on the basis of writing positions of multiple FPs included in the multiple writing requests on the data layout of the storing region 40d.

The sequential determining unit 47 may use the parameters of P, N, and H in the sequential determination. The parameter P represents the number of entries having sequentiality that the sequential determining unit 47 detects (i.e., the number of times that the sequential determining unit 47 detects sequentiality), and may be an integer of two or more. The parameter N is a coefficient for determining the distance between FPs, which serves as a criterion for determining that the positions of the hit FPs are successive on the data layout of the storing region 40d, in other words, for determining that the FPs are sequential, and may be, for example, an integer of one or more. The parameter H is a threshold for performing prefetching, and may be, for example, an integer of two or more. In the following description, it is assumed that P=8, N=16, and H=5.

For example, when the hit FP locates at the position of ±(α×N) (within a first given range) from the position of the last hit FP (e.g., at the immediately preceding writing request) on the data layout of the storing region 40d, the sequential determining unit 47 may determine that the FPs are sequential. The symbol α represents the data size of an FP and is, for example, eight bytes. The case of N=+1 can be said to be truly sequential, but N may be a value of 2 or more with a margin in consideration of switching the sequence of the I/O. Thus, even if the FPs are not successive on the data layout of the storing region 40d, the sequential determining unit 47 can determine that the FPs are sequential if the hit FPs are within the distance of ±(α×N).

As another example, the sequential determining unit 47 may determine that the FPs are sequential if the FPs on the data layout of the storing region 40d are hit H times or more. As the above, the sequential determining unit 47 can enhance the accuracy of the sequential determination by determining that the FPs have sequentiality after the FPs are hit a certain number of times.

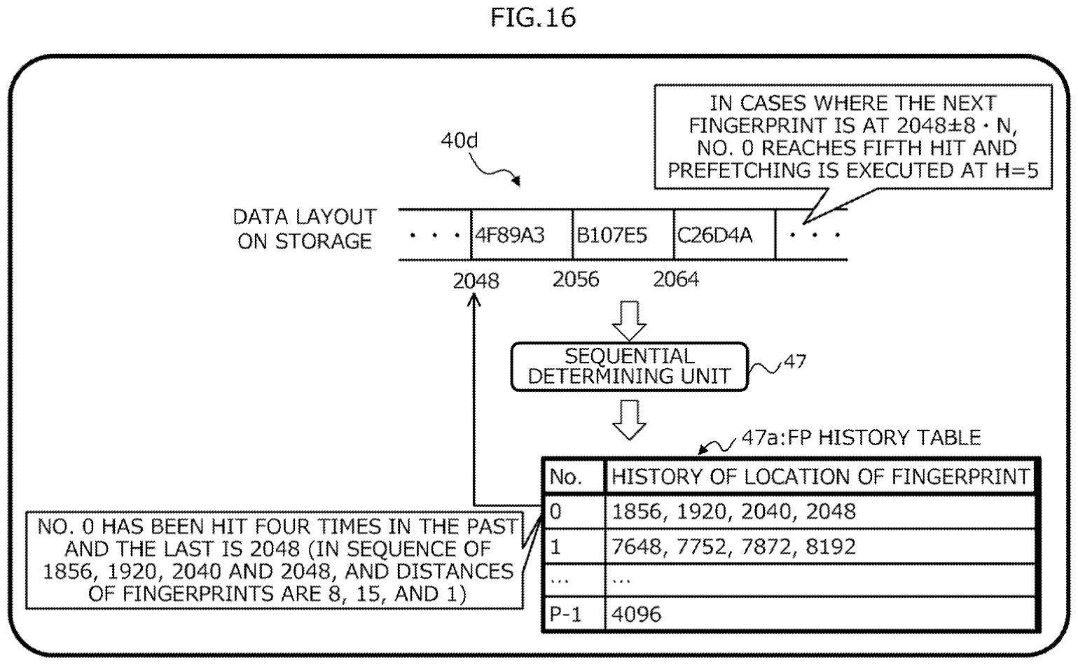

FIG. 16 is a diagram illustrating an example of an FP history table 47a. In the following description, the FP history table 47a is assumed to be data in a table form, for convenience, but is not limited thereto. Alternatively, the FP history table 47a may be in various data forms such as a Database (DB) or an array. As illustrated in FIG. 16, the FP history table 47a may illustratively include P entries that hold histories of the locations of FPs. For example, the sequential determining unit 47 may detect sequentiality of P FPs based on the FP history table 47a.

In the example of FIG. 16, the FPs in the entry of “No. 0” are hit four times in the past in the sequence of “1856”, “1920”, “2040” and “2048” on the data layout of the storing region 40d, and the last is “2048”. The distances between the FPs are “8”, “15”, and “1”. For example, when the hit FP locates at the position of ±(8×N) from “2048” which is the position of the last hit FP on the data layout of the storing region 40d, the “No. 0” reaches fifth hit and, in the case of the sequential determining unit 47 determines that the FPs are sequential. The sequential determining unit 47 may delete the entry (No. 0 in the example of FIG. 16) detected to be hit H times from the FP history table 47a.

When replacing the entries in the FP history table 47a, the sequential determining unit 47 may replace the entries that are not used for a fixed interval or more or that have values at the nearest location to the accessed FP.

As described above, the sequential determining unit 47 may detect the sequentiality of multiple writing requests in cases where, regarding the multiple FPs that are stored in the storing region 40d and matching the FPs included in the multiple writing requests, a given number of pairs of neighboring FPs in a sequence of receiving the multiple writing requests on the data layout each fall within the first given range.

The parameter adjusting unit 48 adjusts the above-described parameters used for the sequential determination. For example, the parameter adjusting unit 48 may perform parameter adjustment when the sequential determination is performed under an eased condition, and cause the sequential determining unit 47 to perform the sequential determination based on the adjusted parameters.

For example, in cases where the FPs are not determined to be sequential in the sequential determination by the sequential determining unit 47, the parameter adjusting unit 43 adjusts the parameters such that the condition for determining that the FPs are sequential is eased.

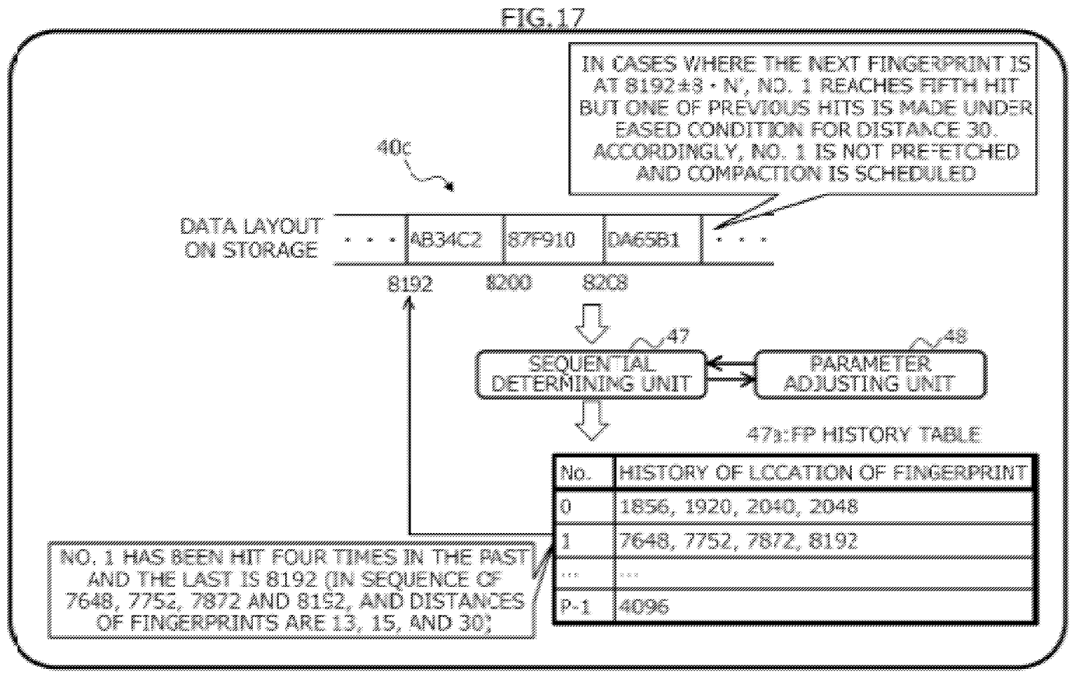

As illustrated in an example of FIG. 17, the parameter adjusting unit 48 increases the value of N such that FPs are easily determined to be sequential even if unrequired data is included, and causes the sequential determining unit 47 to retry the determination. In the one embodiment, the parameter adjusting unit 48 is assumed to double the value of N, e.g., increases 16 to 32. Hereinafter, N after the adjustment is denoted as N′. The parameter adjusting unit 48 may adjust any one of P, N, and H, or a combination of two or more of these parameters.

When the hit occurs H times, the sequential determining unit 47 calculates the distance between each pair of neighboring FPs from the corresponding entries in the FP history table 47a and determines whether or not there is a distance larger than the distance based on N′ after the parameter adjustment. When there are one or more distances larger than the distance based on N′, since the sequential determination is made under an eased condition, the sequential determining unit 47 inhibits the prefetching unit 40a from executing prefetching and the process shifts to the compaction determination to be made by the compaction determining unit 49. On the other hand, when there is no distance larger than the distance based on N′, the sequential determining unit 47 may determine that the FPs have the sequentiality.

As described above, in cases where the sequentiality of multiple writing requests is not detected in the determination based on the first, given range, the sequential determining unit 47 may detect the sequentiality of the multiple writing requests based on the second given range (e.g., ±(α×N′)) including the first given range. In the event of detecting the sequentiality in the determination based on the second given range, the sequential determining unit 47 may suppress the prefetching by the prefetching unit 40a.

The prefetching unit 40a prefetches an FP and transfers the prefetched FP to the computing server 2. For example, in cases where the sequential determining unit 47 determines (detects) the presence of the sequentiality, in other words, the sequential determination is successful, the prefetching unit 40a may determine to execute prefetching and schedule the prefetching.

For example, in prefetching, the prefetching unit 40a may read an FP subsequent to the multiple FPs received immediately before, e.g., a subsequent FP on the data layout of the storing region 40d, and transmit the read subsequent FP to the computing server 2.

As an example, the prefetching unit 40a may obtain the information on the FP subsequent to the FPs which have been hit H times in the sequential determining unit 47 through the first layout managing unit 44 and notify the obtained information to the computing server 2 through the network IF unit 40e.

If it is determined that there are one or more distances equal to or longer than the distance based on N′ adjusted by the parameter adjusting unit 48, the prefetching unit 40a may suppress the execution of prefetching because the sequential determination is performed in a state in which the condition is eased. On the other hand, if there is no distance equal to or longer than the distance based on N′, the prefetching unit 40a may determine to execute prefetching.

Upon receiving the FP transmitted by the prefetching unit 40a, the storage component 20 of the computing server 2 may store the received FP into the contents cache 20a. This makes it possible for the computing server 2 to use the prefetched FP in processing by the deduplication determining unit 22 at the time of transmitting the next writing request.

The compaction determining unit 49 determines whether or not to perform compaction. For example, the compaction determining unit 49 may make a determination triggered by one or both of a prefetching hit and sequential determination.

### (Compaction Triggered by Prefetching Hit)

In the event of a prefetching hit, the compaction determining unit 49 refers to entries around the hit FP in the hit history table 46a, and marks, as unrequired date, an entry having a difference in the hit number. An example of the entry having a difference in the hit number may be one having the hit number equal to or less than a hit number obtained by subtracting a given threshold (first threshold) from the maximum hit number among the entries around the hit FP or from the average hit number of the entries around the hit FPs.

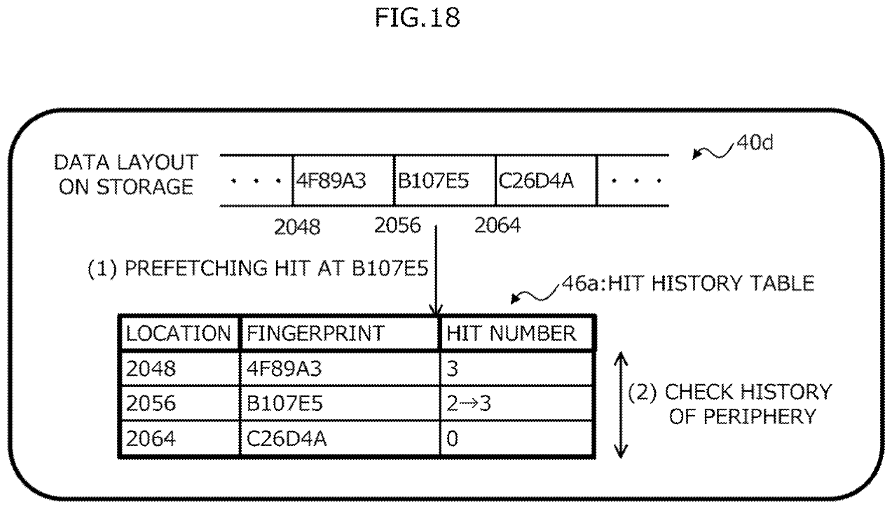

FIG. 18 is a diagram illustrating an example of a compaction process triggered by a prefetching hit. For example, when a prefetching hit occurs on the FP (B107ES) (see reference number (1)), the compaction determining unit 49 may refer to the n histories in the periphery of the entries of the FP (B107E5) in the hit history table 46a (see reference number (2)) to detect unrequired data.

In the first example, the compaction determining unit 49 may recognize, as unrequired data, each entry having a hit number equal to or less than a value obtained by subtracting a threshold from the maximum hit number among 11 (n is an integer of one or more) histories. If n=3 and threshold value is 2, since the maximum hit number is 3 and the threshold value is 2 in the example of FIG. 18, the compaction determining unit 49 recognizes [C26D4A] having a hit number equal to or less than one as unrequired data.

In the second example, the compaction determining unit 49 may recognize, as unrequired data, each entry having a hit number equal to or less than a value obtained by subtracting a threshold from the average hit number among n histories. If n=3 and threshold value is 1, since the average hit number is 2 and the threshold value is 1 in the example of FIG. 18, the compaction determining unit 49 recognizes [C26D4A] having a hit number equal to or less than one as unrequired data.

Then, the compaction determining unit 49 may schedule the compaction when the number of unrequired data is equal to or larger than a threshold (second threshold) among the n history in the periphery.

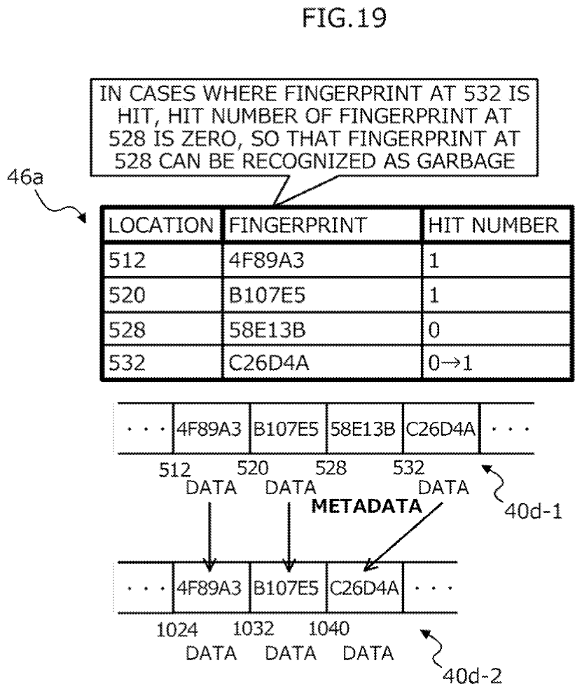

FIG. 19 is a diagram illustrating an example of a compaction process. In the example of FIG. 29, it is assumed that, in the event of a prefetching hit, the compaction determining unit 49 refers to n entries around the hit entry in the hit history table 46a, determines that the hit entry has unrequired data when a hit number is zero, and carries out compaction if detecting one or more unrequired data.

In the example of FIG. 19, assuming that the FP at “532” is hit, the compaction determining unit 49 may determine that the FP [58E13B] at “528” is unrequired data because the FP at “529” has a hit number of “0”, and schedule compaction after the determination.

For example, the first layout managing unit 44 may arrange, in another storing region 40d-2, the FPs [4F89A3], [B107E5], and [C26D4A], which are obtained by excluding the FP [58E13B] of “528” in the storing region 40d-1, by the scheduled compaction. The compaction determining unit 49 may update the locations of the FPs after the arrangement onto the storing region 40d-2 in the hit history table 46a.

As described above, when receiving a writing request containing an FP that matches the FP transmitted in the prefetching (in the case of a prefetching hit), the compaction determining unit 49 may select an FP to be excluded on the basis of the hit history table 46a. Then, the compaction determining unit 49 may move one or more FPs except for the selected removing target FP among multiple fingerprints stored in the first region 40d-1 of the storing region 40d to the second region 40d-2 of the storing region 40d.

### (Compaction Triggered by Sequential Determination)

When an entry is hit H times in the sequential determination, the compaction determining unit 49 calculates the distances of each pair of FPs in the corresponding entry in the FP history table 47a, and determines whether or not a distance equal to or longer than the distance based on N exists. If a distance equal to or longer than the distance based on N exists, the compaction determining unit 49 schedules compaction to exclude unrequired data.

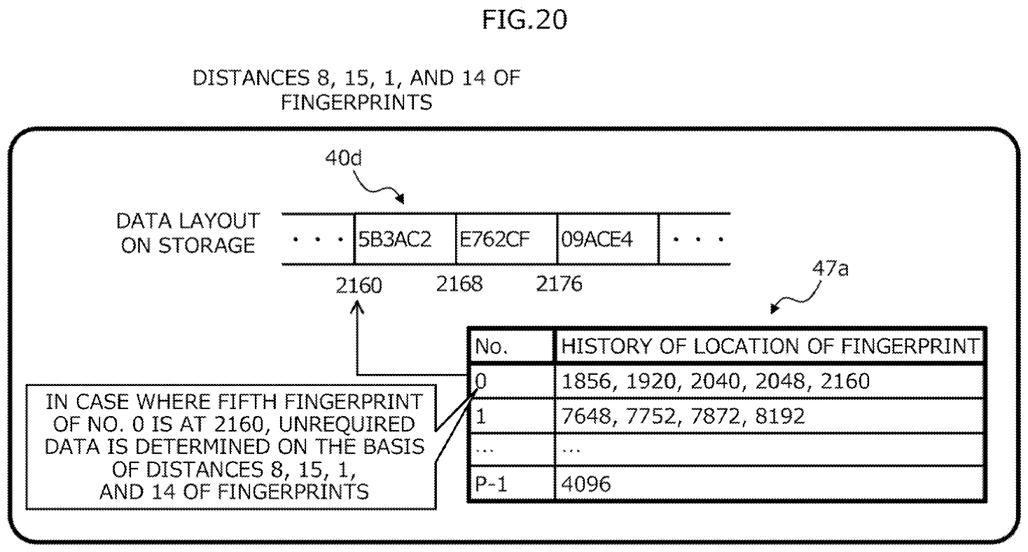

FIG. 20 is a diagram illustrating an example of a compaction process triggered by sequential determination.

In the first example, the compaction determining unit 49 may determine to execute compaction if there are m (m is an integer of one or more) or more FPs having distances equal to or longer than a value (N-threshold) obtained by subtracting a threshold from N. If N=16, the threshold (third threshold)=2, and m=2, since the entry “No. 0” has two distances of “14” or more in the example of FIG. 20, the compaction determining unit 49 schedules compaction.

In the second example, the compaction determining unit 49 may determine to execute compaction when the average value of the distances is equal to or greater than a value (N-threshold) obtained by subtracting a threshold from N. If N=16 and the threshold (fourth threshold)=7, in the example of FIG. 20, since the average value of the distances in the entry “No. 0” is “9.75”, which is “9” or more, the compaction determining unit 49 schedules compaction.

In the compaction triggered by the sequential determination, the compaction determining unit 49 may determine an FP existing between FPs separated by a distance (N-threshold) obtained by subtracting a threshold from N or more on the data layout of the storing region 40d as unrequired data of removing target. As illustrated in FIG. 19, the first layout managing unit 44 may arrange, in the storing region 40d-2, FPs remaining after excluding unrequired data from the FPs in the storing region 40d-1.

As described above, in cases where the sequential determining unit 47 detects the sequentiality based on the second given range, the compaction determining unit 49 may select a removing target FP on the basis of writing positions of the FPs neighboring on the data layout and the first given range. Then, the compaction determining unit 49 may move one or more FPs remaining after excluding the selected removing target. FP among multiple FPs stored in the first region 40d-1 of the storing region 40d to the second region 40d-2 of the storing region 40d.

### <1-4> Example of Operation:

Next, description will now be made in relation to an example of operation of the block storage system 1 according to the one embodiment.

### <1-4-1> Example of Operation of Computing Server:

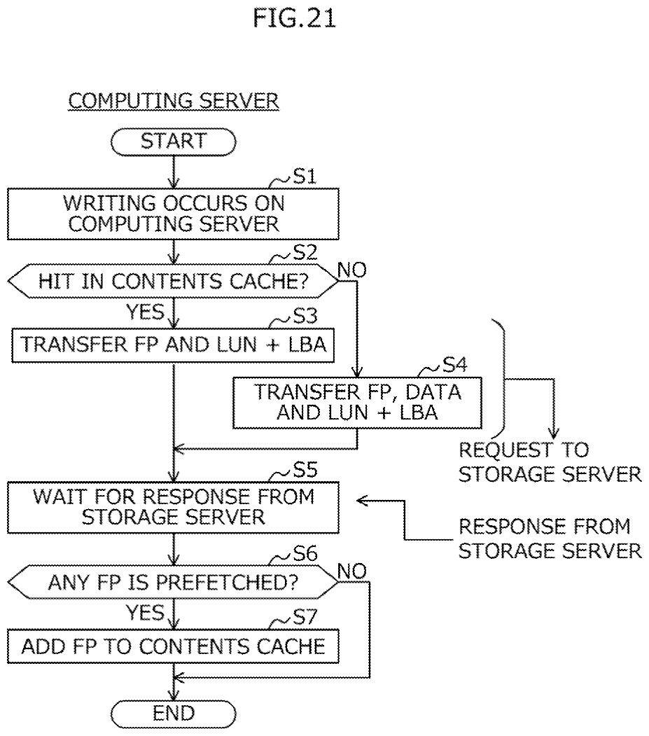

FIG. 21 is a flow diagram illustrating an example of operation of the computing server 2 according to the one embodiment. As illustrated in FIG. 21, writing occurs in the computing server 2 (Step S1).

The dirty data managing unit 21 of the storage component 20 determines whether or not the FP of the writing target data is hit in the contents cache 20a, using the deduplication determining unit 22 (Step S2).

When a cache hit occurs in the contents cache 20a (YES in Step S2), the dirty data managing unit 21 transfers the FP and the LUN+LBA to the storage server 4 (Step S3), and the process proceeds to Step S5.

When a cache hit does not occur in the contents cache 20a (NO in Step S2), the dirty data managing unit 21 transfers the writing target data, the FP, and the LUN+LBA to the storage server 4 (Step S4), and the process proceeds to Step S5.

The dirty data managing unit 21 waits, from the storage server 4, for a response to requests transmitted to the storage server 4 in Steps S3 and S4 (Step S5).

The dirty data managing unit 21 analyzes the received response, and determines whether or net the prefetched FP is included in the response (Step S6). If the prefetched FP is not included in the response (NO in Step S6), the process ends.

In cases where the prefetched FP is included in the response (YES in Step S6), the dirty data managing unit 21 adds the received FP to the contents cache 20a through the FP managing unit 23 (Step S7), and then the writing process by the computing server 2 ends.

The computing server 2 executes the process illustrated in FIG. 21 in units of data to be written. Therefore, in Step S7, adding the FP received from the storage server 4 to the contents cache 20a makes it possible to increase the possibility that the FP of the subsequent data is hit in the contents cache 20a in Step S2.

### <1-4-2> Example of Operation of Storage Server:

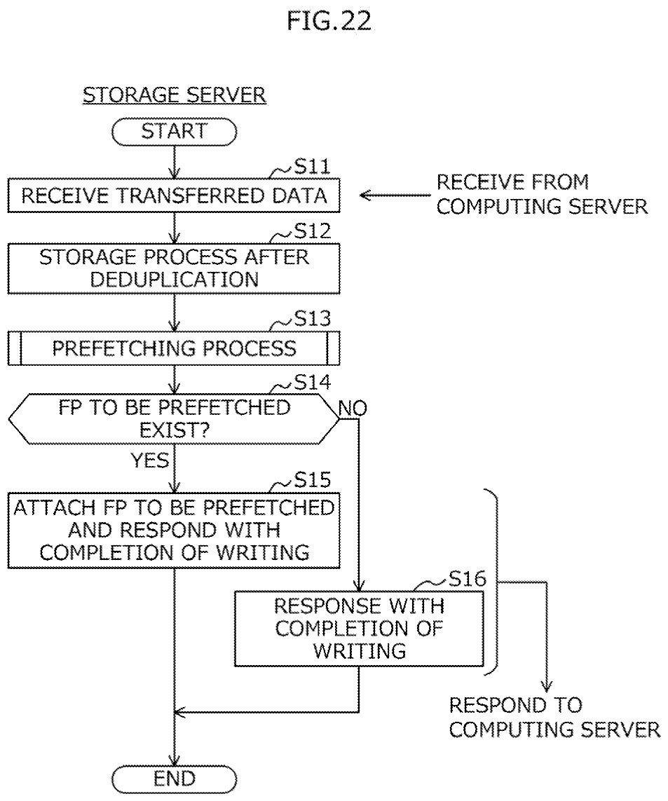

FIG. 22 is a flow diagram illustrating an example of operation of the storage server 4 according to the one embodiment. As illustrated in FIG. 22, the storage server 4 receives the data transferred in Step S3 or S4 (see FIG. 21) from the computing server 2 (Step S11).

The storage server 4 causes the first managing unit 41 and the second managing unit 42 to execute a storage process after the deduplication (Step S12). The storage process may be, for example, similar to that of a storage server in a known block storage system.

The storage server 4 performs a prefetching process (Step S13). The prefetching unit 40a determines whether or not an FP to be prefetched exists (Step S14).

If an FP to be prefetched exists (YES in Step S14), the prefetching unit 40a responds to the computing server 4 with the completion of writing while attaching the FP to be prefetched (Step S15), and the receiving process by the storage server 4 ends.

If the FP to be prefetched does not exist (NO in step S14), the storage server 4 responds to the computing server 2 with the completion of writing (Step S16), and the receiving process by the storage server 4 ends.

### <1-4-3> Example of Operation of Prefetching Process by Storage Server:

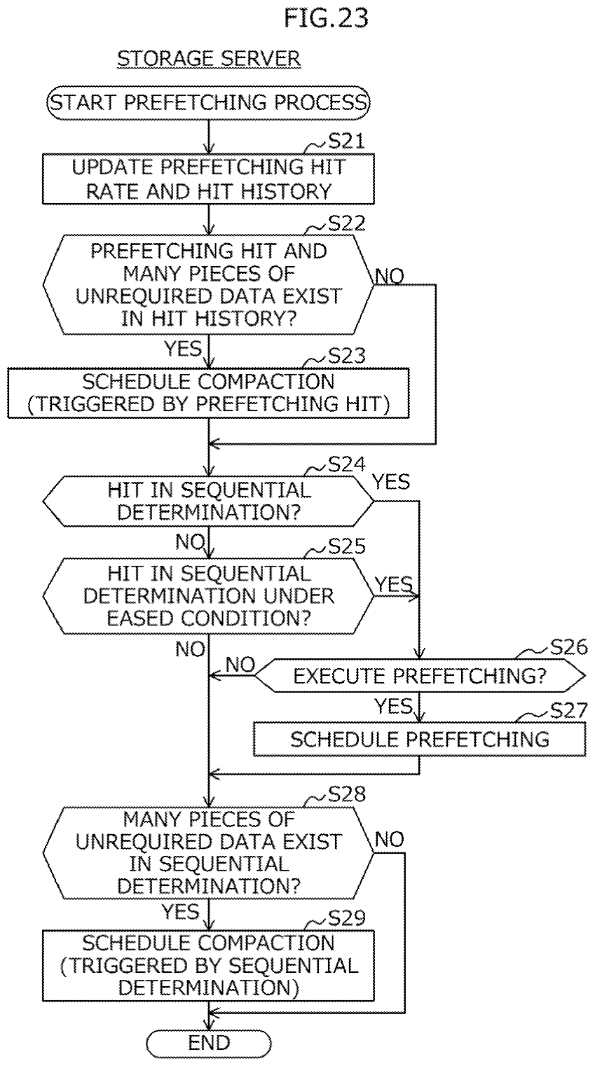

FIG. 23 is a flow diagram illustrating an example of operation of the prefetching process by the storage server 4 illustrated in Step S13 of FIG. 22. As illustrated in FIG. 23, the hit rate and history managing unit 46 of the storage server 4 updates the prefetching hit rate and the hit history (hit history table 46a) (Step S21).

On the basis of the hit history table 46a, the compaction determining unit 49 determines whether or not a prefetching hit exists and many pieces of unrequired data exist in the hit history (Step S22). For example, as illustrated in FIG. 18, the compaction determining unit 49 determines whether or not the number of pieces of unrequired data is equal to or larger than a threshold (second threshold) among the n history in the periphery.

If a prefetching hit does not exist, or not many pieces of unrequired data exist in the hit history (NO in Step S22), the process proceeds to Step S24.

If a prefetching hit exists or many pieces of unrequired data exist in the hit history (YES in Step S22), the compaction determining unit 49 schedules compaction triggered by prefetching hit (Step S23) and the process proceeds to Step S24.

The sequential determining unit 47 performs sequential determination based on the FP history table 47a and the FP received from the computing server 2, and determines whether or not the FP is hit in the FP history table 47a (Step S24).

If the FP is not hit (NO in Step S24), the sequential determining unit 47 and the parameter adjusting unit 48 perform the sequential determination under an eased condition (parameters), and determine whether or not the FP is hit in the FP history table 47a (Step S25).

If the FP is not hit in Step S25 (NO in Step S25), the process proceeds to Step S28. On the other hand, if the FP is hit. in Step S25 (YES in Step S24 or YES in Step S25), the process proceeds to Step S26.

In Step S26, the prefetching unit 40a determines whether or not to perform prefetching. If the prefetching is not to be performed, for example, in Step S26 executed via YES in step S25 (NO in Step S26), the process proceeds to Step S28.

If the prefetching is to be performed, for example, in Step S26 executed via YES in Step S24 (YES in Step S26), the prefetching unit 40a schedules prefetching (Step S27), and the process proceeds to Step S28.

In Step S28, the compaction determining unit 49 determines whether or not many pieces of unrequired data exist on the basis of the FP history table 47a at the time of the sequential determination. For example, as illustrated in FIG. 20, the compaction determining unit 49 determines whether or not m or more distances equal to or longer than the distance (N-threshold (third threshold)) exist, or whether or not the average value of the distances is equal to or longer than the distance (N-threshold (fourth threshold)).

If many pieces of unrequired data do not exist at the time of the sequential determination (NO in Step S28), the prefetching process ends.

If many pieces of unrequired data exist at the time of the sequential determination (YES in Step S28), the compaction determining unit 49 schedules compaction triggered by the sequential determination (Step S29), and the prefetching process ends.

The compaction scheduled in Steps S23 and S29 is performed by the first layout managing unit 44 at a given timing. The prefetching scheduled in Step S27 is performed by the prefetching unit 40a at a given timing (for example, at Step S15 in FIG. 22).

### <1-5> Application Example

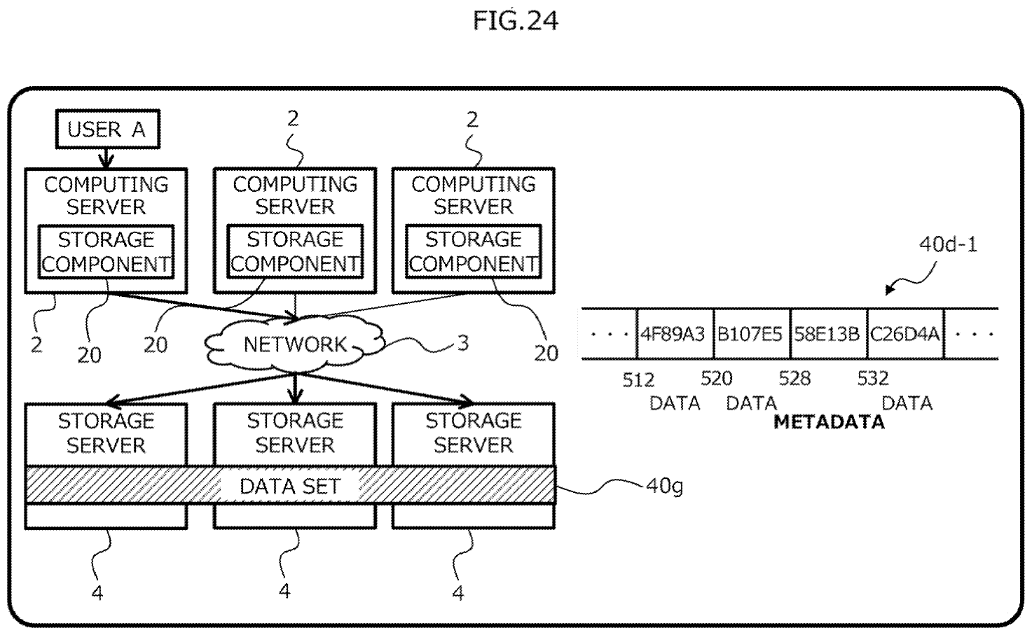

Hereinafter, description will now be made in relation to an application example of the scheme according to the one embodiment with reference to FIGS. 24 to 26. In the application example, it is assumed that users A to C using respective computing servers 2 perform machine learning by using the same 1-PS data set 40g on the storage server 4.

As illustrated in FIG. 24, the user A writes the 1-PB data set 40g into the storage 40c of the storage server 4. The following explanation assumes that the unit of deduplication is 4 KiB and the average file size is 8 KiB. Further, as illustrated in the storing region 40d-1, it is assumed that file metadata (denoted as “metadata”) or an FP of journaling is written once after the FPs (denoted as “data”) of the file are written twice. Furthermore, it is assumed that metadata or journaling is not duplicated and therefore becomes unrequired data.

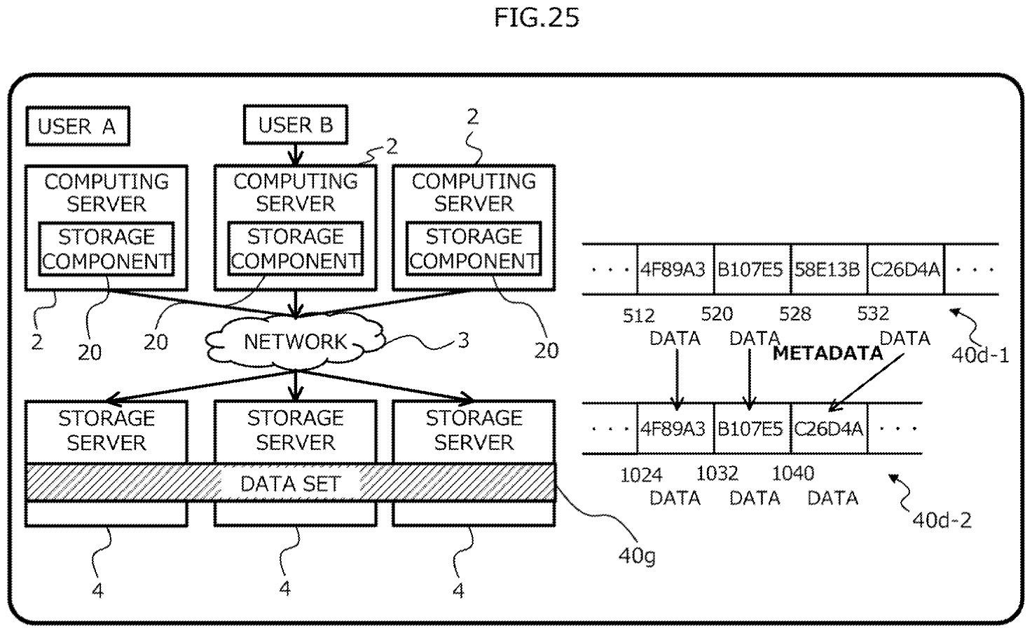

Next, as illustrated in FIG. 25, the user B writes the data set 40g into the storage 40c of the storage server 4 from another computing server 2 (which may be the same computing server 2 of the user A). In writing from the computing server 2 used by the user B, the sequential determination is made in the storage server 4 after first several files are written, and if the prefetching succeeds, the data transfer does not occur, so that the data traffic can be reduced. At this time, since one-third of the FP to be prefetched is detected to be unrequired data by the sequential determining unit 47 and the compaction determining unit 49, the compaction from the storing region 40d-1 to the storing region 40d-2 is carried out. Also, even when the sequential determination fails and the data traffic is not reduced, the compaction triggered by the sequential determination is performed.

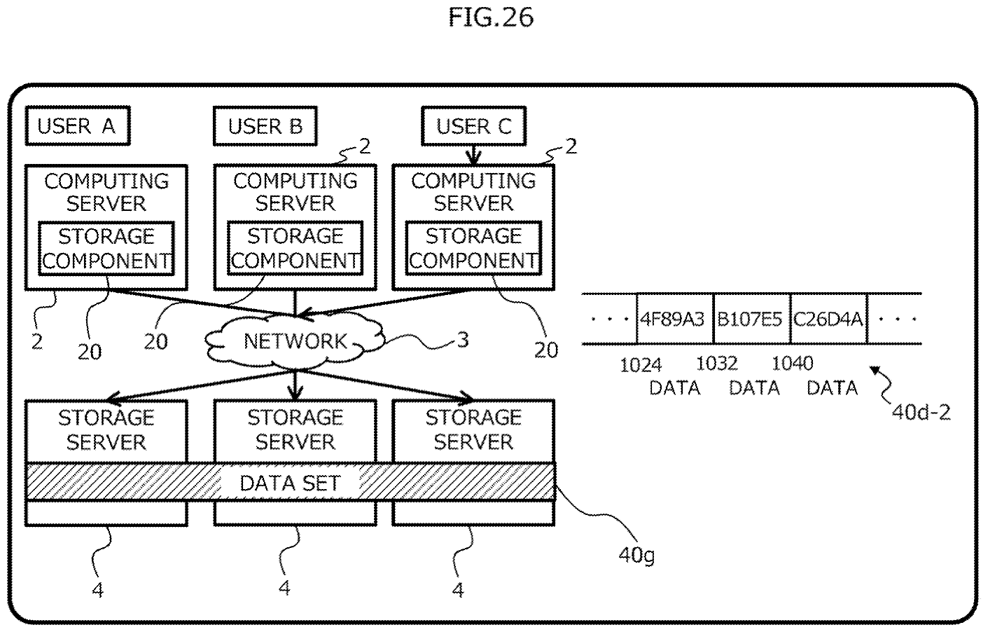

Next, as illustrated in FIG. 26, the user C writes the data set 40g into the storage 40c of the storage server 4 from another computing server 2 (which may be the same computing server 2 of the user A or B). Since the compaction has been performed at the time of the writing by the user B, the sequential determination and the prefetching are carried out, and the data transfer can be suppressed as compared to the time of writing by the user B, and consequently, the data traffic can be reduced.

For example, when it is assumed that the data traffic of LUN+LBA is 8+8=16 B and that of FP is 20 B, a conventional method uses a communication size of 4096+16+20=4132 B each time. On the ether hand, assuming that the deduplication succeeds for all data, the scheme of the one embodiment uses a communication size of 16+20=36 B each time. In the writing of the 1-PB data set 40g, since the number of times of communication is 2⁽⁵⁰⁻¹²⁾=2³⁸, the data traffic can be reduced from 4132×2³⁸ B to 36×2³⁸ B. Being expressed in a percentage, the data traffic can be reduced to 36/4132=0.87%.

The data transfer amount of FPs from the storage server 4 to the computing server 2 in an ideal case is 20×2³⁸ B. In the case of the writing by the user B illustrated in FIG. 25, since one piece of unrequired data is included in per two pieces of data, the data transfer amount is about. 1.5 times larger than that in the writing by the user C. On the ether hand, in the case of the writing by the user C illustrated in FIG. 26, the data transfer amount can be close to an ideal value of 20×2³⁸ B as a result of compaction.

The example described above is a case where the one embodiment is applied to a use case in which a large effect on reducing the data traffic is expected. The effect on reducing the data traffic by the scheme of the one embodiment varies with, for example, a use case, workload, and a data set. Thus, various conditions such as parameters for processes including sequential determination, compaction, prefetching, and the like according to the above-described one embodiment may be appropriately adjusted according to, for example, a use case, workload, and a data set.

### <1-6> Example of Hardware Configuration:

The devices for achieving the above-described computing server 2 and storage server 4 may be virtual servers (VMs; Virtual Machines) or physical servers. The functions of each of the computing server 2 and the storage server 4 may be achieved by one computer or by two or more computers. Further, at least some of the respective functions of the computing server 2 and the storage server 4 may be implemented using Hardware (HW) and Network (NW) resources provided by cloud environment.

The computing server 2 and storage server 4 may be implemented by computers similar to each other. Hereinafter, the computer 10 is assumed to be an example of a computer for achieving the functions of each of the computing server 2 and the storage server 4.

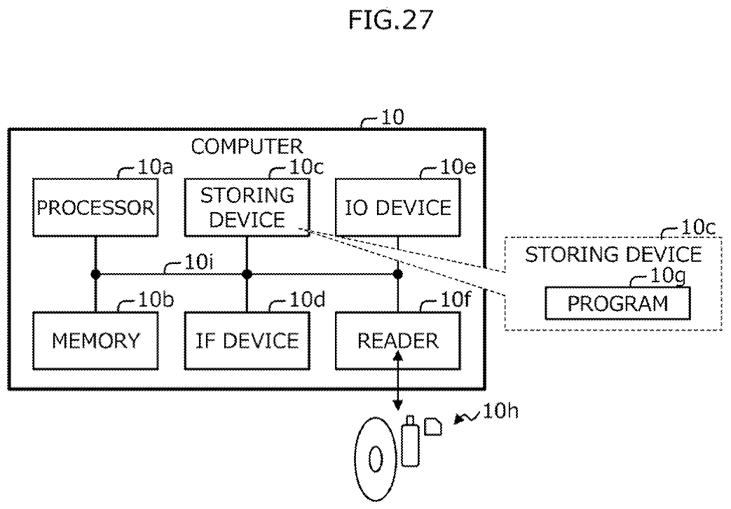

FIG. 27 is a block diagram illustrating an example of a hardware (HW) configuration of the computer 10. When multiple computers are used as the HW resources for implementing the functions of the computing server 2 and the storage server 4, each computer may have the HW configuration illustrated in FIG. 27.

As illustrated in FIG. 27, the computer 10 may exemplarily include, as the HW configuration, a processor 10a, a memory 10b, a storing device 10c, an IP (Interface) device 10d, an I/O (Input/Output) device 10e, and a reader 10f.

The processor 10a is an example of an arithmetic processing apparatus that performs various controls and arithmetic operations. The processor 10a may be connected to each block in the computer 10 so as to be mutually communicable via a bus 10i. The processor 10a may be a multiprocessor including multiple processors, or a multi-core processor including multiple processor cores, or may have a configuration including multiple multi-core processors.

An example of the processor 10a is an Integrated Circuit (IC) such as a Central Processing Unit (CPU), a Micro Processing Unit (MPU), a Graphics Processing Unit (GPU), an Accelerated Processing Unit (APU), a Digital Signal Processor (DSP), an Application Specific IC (ASIC), and a Field-Programmable Gate Array (FPGA). The processor 10a may be a combination of two or more ICs exemplified as the above.

The memory 10b is an example of a HW device that stores information such as various data and programs. An example of the memory 10b includes one or both of a volatile memory such as a Dynamic Random Access Memory (DRAM) and a non-volatile memory such as a Persistent Memory (PM).

The storing device 10c is an example of a HW device that stores information such as various data and programs. Examples of the storing device 10c include various storing devices exemplified by a magnetic disk device such as a Hard Disk Drive (HDD), a semiconductor drive device such as a Solid State Drive (SSD), and a non-volatile memory. Examples of a non-volatile memory are a flash memory, a Storage Class Memory (SCM), and a Read Only Memory (ROM).

The information on the contents cache 20a that the computing server 2 stores may be stored in one or more storing regions that one or both of the memory 10b and the storing device 10c include. Each of the storage 40c and the storing region 40a of the storage server 4 may be implemented by one or more storing regions that one or both of the memory 10b and the storing device 10c include. Furthermore, the information on the hit history table 46a and the FP history table 47a that the storage 40c stores may be stored in one or more storing regions that one or both of the memory 10b and the storing device 10c include.

The storing device 10c may store a program 10g (information processing program) that implements all or part of the functions of the computer 10. For example, the processor 10a of the computing server 2 can implement the function of the storage component 20 illustrated in FIG. 9 and the functions of the blocks 21-23 illustrated in FIG. 14 by, for example, expanding the program 10g stored in the storing device 10c onto the memory 10b and executing the expanded program. The processor 10a of the storage server 4 can implement the functions of the prefetching unit 40a and the deduplicating and compacting unit 40b illustrated in FIG. 9 and the functions of the blocks 41-49 illustrated in FIG. 14 by expanding the program 10g stored in the storing device 10c onto the memory 10b and executing the expanded program.

The IF device 10d is an example of a communication IF that controls connection to and communication of a network between the computing servers 2, a network between the storage servers 4, and a network between the computing server 2 and the storage server 4, such as the network 3. For example, the IF device 10d may include an adaptor compatible with a Local Area Network (LAN) such as Ethernet (registered trademark), an optical communication such as Fibre Channel (FC), or the like. The adaptor may be compatible with one or both of wired and wireless communication schemes. For example, each of the network IF units 20b and 40e illustrated in FIG. 14 is an example of the IF device 10d. Further, the program 10g may be downloaded from a network to the computer 10 through the communication IF and then stored into the storing device 10c, for example.

The I/O device 10e may include one or both of an input device and an output device. Examples of the input device are a keyboard, a mouse, and a touch screen. Examples of the output device are a monitor, a projector, and a printer.

The reader 10f is an example of a reader that reads information on data and programs recorded on a recording medium 10h. The reader 10f may include a connecting terminal or a device to which the recording medium 10h can be connected or inserted. Examples of the reader 10f include an adapter conforming to, for example, Universal Serial Bus (USB), a drive apparatus that accesses a recording disk, and a card reader that accesses a flash memory such as an SD card. The program 10g may be stored in the recording medium 10h. The reader 10f may read the program 10g from the recording medium 10h and store the read program 10g into the storing device 10c.

An example of the recording medium 10h is a non-transitory computer-readable recording medium such as a magnetic/optical disk and a flash memory. Examples of the magnetic/optical disk include a flexible disk, a Compact Disc (CD), a Digital Versatile Disc (DVD), a Blu-ray disk, and a Holographic Versatile Disc (HVD). An examples of the flash memory includes a semiconductor memory such as a USB memory and an SD card.

The HW configuration of the computer 10 described above is merely illustrative. Accordingly, the computer 10 may appropriately undergo increase or decrease of HW (e.g., addition or deletion of arbitrary blocks), division, integration in an arbitrary combination, and addition or deletion of the bus. For example, at least one of the I/O device 10e and the reader 10f may be omitted in one or both of the computing server 2 and the storage server 4.

### <2> Miscellaneous:

The technique according to the one embodiment described above can be implemented by changing or modifying as follows.

For example, the blocks 21 to 23 included in the computing server 2 illustrated in FIG. 14 may be merged in any combination or may each be divided. The blocks 41 to 49 included in the storage server 4 illustrated in FIG. 14 may be merged in any combination or may each be divided.

Further, each of the block storage system 1, the computing server 2, and the storage servers 4 may be configured to achieve each processing function by mutual cooperation of multiple devices via a network. For example, each of the multiple functional blocks illustrated in FIG. 14 may be distributed among servers such as a Web server, an application server, and a DB server. In this case, the processing functions of the block storage system 1, the computing servers 2, and the storage servers 4 may be achieved by the web server, the application server, and the DB server cooperating with one another via a network.

In one aspect, the one embodiment can reduce the data traffic when data is written into an information processing apparatus.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing system comprising:
a first information processing apparatus; and
a second information processing apparatus connected to the first information processing apparatus via a network, wherein
the first information processing apparatus comprises
a first memory,
a first storing region that stores a fingerprint of data, and
a first processor coupled to the first memory and the first storing region,
the first processor is configured to
transmit, in a case where a fingerprint of writing target data to be written into the second information processing apparatus exits in the first storing region, a writing request including the fingerprint to the second information processing apparatus, and
transmit, in a case where the fingerprint does not exist in the first storing region, a writing request containing the writing target data and the fingerprint to
the second information processing apparatus, the second information processing apparatus comprises
a second memory,
a second storing region that stores respective fingerprints of a plurality of data pieces written into a storing device in a sequence of writing the plurality of data pieces, and
a second processor coupled to the second memory and the second storing region,
the second processor is configured to
receive a plurality of the writing requests from the first information processing apparatus via the network,
determine, based on writing positions of the plurality of the fingerprints included in the plurality of writing requests on a data layout of the second storing region, whether or not the plurality of writing requests have sequentiality,
read, when determining that the plurality of writing requests have sequentiality, a subsequent fingerprint to the plurality of fingerprints on the data layout of the second storing region, and
transmit the subsequent, fingerprint to the first information processing apparatus, and
the first information apparatus stores the subsequent fingerprint into the first storing region.

2. An information processing apparatus connected to a first information processing apparatus via a network, the information processing apparatus serving as a second information processing apparatus comprising:
a memory;
a storing device including a storing region that stores respective fingerprints of a plurality of data pieces written into the storing device in a sequence of writing the plurality of data pieces; and
a processor coupled to the memory and the storing device, wherein
the processor is configured to
receive, from the first information processing apparatus via the network, a plurality of writing requests including fingerprints of writing target data to be written into the storing device,
determine, based on writing positions of the plurality of the fingerprints included in the plurality of writing requests on a data layout, of the storing region, whether or not the plurality of writing requests have sequentiality,
read, when determining that the plurality of writing requests have sequentiality, a subsequent fingerprint to the plurality of fingerprints on the data layout of the storing region, and
transmit the subsequent fingerprint to the first information processing apparatus.

3. The information processing apparatus according to claim 2, wherein the processor determines that the plurality of writing requests have sequentiality in a case where a given number of distances between pairs of fingerprints neighboring in a sequence of receiving the plurality of writing requests on the data layout each fall within a first given range, the pairs of fingerprints being stored in the storing region and matching the plurality of the fingerprints included in the plurality of writing requests.

4. The information processing apparatus according to claim 3, wherein the processor
determines that the plurality of writing requests have sequentiality in a case where at least one of the given number of distances do not fall within the first given range and the given number of distances each fall within a second given range including the first given range, and
suppresses transmitting of the subsequent fingerprint in the transmitting.

5. The information processing apparatus according to claim 4, wherein the processor moves, when determining that the plurality of writing requests have sequentiality based on the second given range, one or more fingerprints remaining after excluding one or more removing target fingerprints selected based on a distance between writing positions of two fingerprints neighboring on the data layout and the first given range among multiple fingerprints stored in a first region of the storing region, to a second region of the storing region.

6. The information processing apparatus according to claim 2, wherein the processor
manages information that records a number of times of receiving a writing request including a fingerprint matching one of the fingerprints transmitted in the transmitting, and
moves, when receiving a writing request including a fingerprint matching one of the fingerprints transmitted in the transmitting, one or more fingerprints remaining after excluding one or more removing target fingerprints selected based on the information among multiple fingerprints stored in a first region of the storing region, to a second region of the storing region.

7. A method for processing information performed by a computer connected to a first computer via a network, the computer serving as a second computer, the method comprising:
receiving a plurality of writing requests to be written into a storing device from the first computer via the network, the storing device including a storing region that stores respective fingerprints of a plurality of data pieces written into the storing device in a sequence of writing the plurality of data pieces;
determining, based on writing positions of the plurality of the fingerprints included in the plurality of writing requests on a data layout of the storing region, whether or not the plurality of writing requests have sequentiality;
reading, when determining that the plurality of writing requests have sequentiality, a subsequent fingerprint to the plurality of fingerprints on the data layout of the storing region; and
transmitting the subsequent fingerprint to the first computer.

8. The method according to claim 7, wherein the detecting comprises determining that the plurality of writing requests have sequentiality in a case where a given number of distances between pairs of fingerprints neighboring in a sequence of receiving the plurality of writing requests on the data layout each fall within a first given range, the pairs of fingerprints being stored in the storing region and matching the plurality of the fingerprints included in the plurality of writing requests.

9. The method according to claim 8, wherein
the determining comprises detecting that the plurality of writing requests have sequentiality in a case where at least one of the given number of distances do not fall within the first given range and the given number of distances each fall within a second given range including the first given range, and
the transmitting comprises suppressing transmitting of the subsequent fingerprint in the transmitting.

10. The method according to claim 9, further comprising moving, when determining chat the plurality of writing requests have sequentiality based on the second given range, one or more fingerprints remaining after excluding one or more removing target fingerprints selected based on a distance between writing positions of two fingerprints neighboring on the data layout and the first given range among multiple fingerprints stored in a first region of the storing region, to a second region of the storing region.

11. The method according to claim 7, further comprising:
managing information that records a number of times of receiving a writing request including a fingerprint matching one of the fingerprints transmitted in the transmitting, and
moving, when receiving a writing request including a fingerprint, matching one of the fingerprints transmitted in the transmitting, one or more fingerprints remaining after excluding one or more removing target fingerprints selected based on the information among multiple fingerprints stored in a first region of the storing region, to a second region of the storing region.
